(19) United States
(12) Patent Application Publication
(10) Pub. No.: US 2006/0187786 A1
(43) Pub. Date: Aug. 24, 2006

(54) Optical information recording and reproducing apparatus

(75) Inventor: Shinnosuke Torii, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/344,240

(22) Filed: Feb. 1, 2006

(30) Foreign Application Priority Data
Feb. 24, 2005 (JP) 2005-048993

(51) Int. Cl. G11B 7/00

(52) U.S. Cl. 369/47.54; 369/116

(57) ABSTRACT

It can be determined whether a disc is a single-layer disc or a multilayer disc without causing reproducing deterioration while only a main body of the disc is used without being contained in a cartridge. More specifically, when disc type determination is performed, an intensity of laser light (reproducing light quantity) irradiated to the disc is set to a first light quantity for reproducing information from the disc having a signal recording surface of a single layer.

### BACKGROUND OF THE INVENTION

1. Field of the Invention

The present invention relates to an optical information recording and reproducing apparatus using a recording medium including an optical disc having a signal recording surface with a single layer or a multilayer, such as a Blu-ray disc, and more particularly to a reproducing power control technique used in the case of determining whether the disc includes the single layer or the multilayer.

2. Related Background Art

In recent years, an optical disc such as a CD or a DVD is expected to realize higher-density recording with an increase in information to be recorded therein. In order to achieve the higher-density recording as compared with the DVD, it is required that a mark smaller than that for the DVD is recorded on a recording layer. Therefore, it is necessary to shorten a wavelength of a light source and increase a numerical aperture (hereinafter referred to as a “NA”) of an objective lens.

For example, in the case of the DVD, a laser having a wavelength of 660 nm is used as the light source and a lens having a NA of 0.6 is used as the objective lens. When a blue laser having a wavelength of 405 nm is used as the light source and an objective lens having a NA of 0.85 is used, a recording capacity which is equal to approximately 5 times that of the DVD can be obtained. In order to obtain a recording capacity more higher than that of a so-called single-layer disc having a recording layer by using a recent high-power blue laser, a multilayer disc having a plurality of recording layers is under development. Now, a two-layer disc is commercially manufactured as a Blu-ray disc contained in a cartridge.

Therefore, there are two kinds of discs, the single-layer disc and the multilayer disc, in the market and a disc apparatus is expected to adapt to both the discs.

In general, when a power source is turned on or when a disc is inserted into an optical disc apparatus, for example, disc-specific information is reproduced from a preformat area provided in advance in an innermost circumference side of the disc. This information is, for example, recommended reproducing power or recording power. A learning operation for determining parameters including optimum power which is actually used is performed based on the information obtained from the preformat area. Actual recording and reproduction are performed based on various parameters finally obtained through the learning operation.

However, with respect to each of the single-layer disc and the multilayer disc as described above, a reproducing light quantity (quantity of light irradiated from the objective lens to the disc) optimum for each layer significantly depends on disc characteristics such as transmittance and reflectance. For example, in the case of the Blu-ray disc, the reproducing light quantity for the two-layer disc becomes approximately two times the reproducing light quantity for the single-layer disc.

If the single-layer medium is irradiated with light having a quantity equal to the reproducing light quantity for the two-layer medium through the objective lens, reproducing deterioration due to an excess of the reproducing light quantity for the single-layer medium occurs. Therefore, it is likely to cause deterioration of recorded information or corruption thereof. For example, when the above-described deterioration of the preformat information or the corruption thereof occurs, it is impossible to obtain parameters for performing the learning. In addition, it is undeniable that it is likely to cause the deterioration of recorded user information or the corruption thereof.

With regard to such a problem, for example, Japanese Patent Application Laid-Open No. H07-029350 describes a technique for determining whether the recording layer of the disc is composed of the single layer or the multilayer using an identification hole provided in a disc cartridge containing the disc. In other words, the identification hole is provided in an arbitrary position of the disc cartridge. When the disc cartridge is held in a disc apparatus, an open-and-close state of the identification hole is detected to perform determination whether the disc is the single-layer disc or the multilayer disc (hereinafter referred to as “disc type determination”).

FIG. 11 is a flow chart for the disc type determination as described in Japanese Patent Application Laid-Open No. H07-029350. First, when a power source is turned on or when a new disc is inserted and mounted on a spindle motor for rotating the disc. When the disc type determination whether the disc includes the single-layer or the multilayer (S401) is required, the open-and-close state of the identification hole of the cartridge is detected to determine whether the disc is the single-layer disc or the multilayer disc (S402). When it is determined that the disc is the single-layer disc, a reproducing light quantity is adjusted to a reproducing light quantity for the single-layer disc (first light quantity) and the preformat information described above is reproduced (S403).

Next, a recording operation or a reproducing operation is executed (S404). After the recording operation or the reproducing operation is completed, a semiconductor laser serving as a light source is turned OFF (S405). Then, the power source is turned OFF or the disc is ejected (S406), thereby completing processing.

On the other hand, when it is determined in Step S402 that the disc is the multilayer disc, the reproducing light quantity is adjusted to a reproducing light quantity for the multilayer disc (second light quantity) and the preformat information is reproduced as described above (S407). After that, the recording operation or the reproducing operation is executed in a similar manner (S404) . When the operation is completed, the semiconductor laser is turned OFF (S405). Then, the power source is turned OFF or the disc is ejected, thereby completing processing (S406).

In recent years, in order to realize reductions in size, thickness, and weight of each of a disc apparatus and a recording medium, it is expected to use a disc alone which is not contained in a cartridge. This is one of development matters which are unavoidable in the development of a future optical disc apparatus. Therefore, a method of determining whether the disc includes the single layer or the multilayer without using the identification hole of the cartridge is expected unlike Japanese Patent Application Laid-Open No. H07-029350.

As another disc type determining method, for example, there is a method of detecting a peak of a focus signal produced by moving an objective lens in a direction perpendicular to a disc surface by an objective lens actuator. In this method, when a single peak is detected, it is determined that the disc includes the single layer. When two peaks are detected, it is determined that the disc includes the two layers.

However, if the disc type determination is performed on the single layer disc at the reproducing light quantity for the multilayer disc (second light quantity), the reproducing deterioration occurs as described above. It is likely to cause the corruption of recorded user information depending on a focused location.

### SUMMARY OF THE INVENTION

An object of the present invention is to provide an optical information recording and reproducing apparatus capable of determining whether a recording medium is a single layer recording medium or a multilayer recording medium without causing reproducing deterioration while only the recording medium is used without being contained in a cartridge.

Specifically, the optical information recording and reproducing apparatus, includes: a light source; an objective lens for focusing laser light from the light source on an optical recording medium having a signal recording surface of a single layer or a multilayer to perform information recording or information reproduction; a determining circuit for determining number of layers of the signal recording surface of the optical recording medium; and an adjusting circuit for adjusting an intensity of the laser light irradiated to the optical recording medium, and in the optical information recording and reproducing apparatus, when the determining circuit determines the number of layers, the adjusting circuit sets an intensity of the laser light irradiated to the optical recording medium to an intensity for reproducing information from the optical recording medium.

### BRIEF DESCRIPTION OF THE DRAWINGS

FIG. 1 is a block diagram showing a first embodiment of the present invention;

FIG. 2 is a structural view showing an optical system of an optical pickup according to the first embodiment of the present invention;

FIG. 3 is a flow chart showing a disc type determining operation according to the first embodiment of the present invention;

FIG. 4 is an explanatory graph showing a method of performing disc type determination based on a peak of a reflection light quantity;

FIG. 5 is a block diagram showing a second embodiment of the present invention;

FIG. 6 is a structural view showing an optical system of an optical pickup according to the second embodiment of the present invention;

FIG. 7 is a flow chart showing a disc type determining operation according to the second embodiment of the present invention;

FIG. 8 is a block diagram showing a third embodiment of the present invention;

FIG. 9 is a structural view showing an optical system of an optical pickup according to the third embodiment of the present invention;

FIG. 10 is a flow chart showing a disc type determining operation according to the third embodiment of the present invention; and

FIG. 11 is a flow chart showing a conventional disc type determining operation.

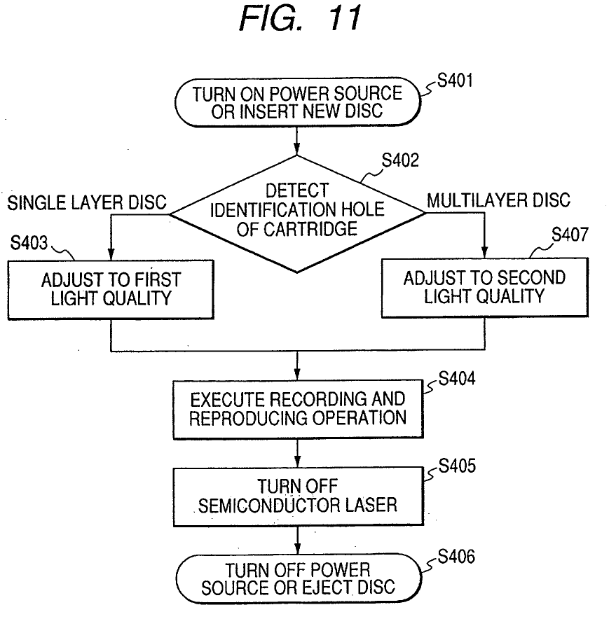

### DESCRIPTION OF THE PREFERRED EMBODIMENTS

Hereinafter, best modes for carrying out the present invention will be described in detail with reference to the accompanying drawings.

### First Embodiment

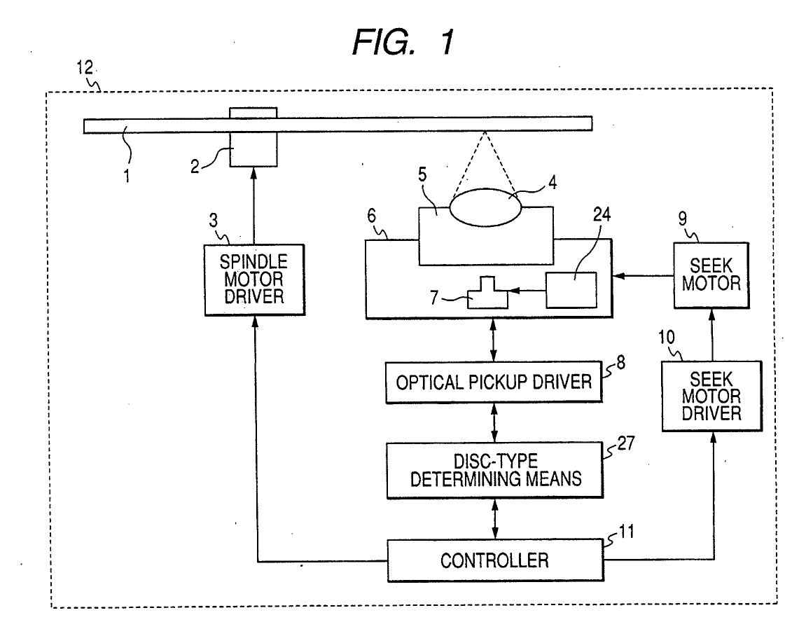

FIG. 1 is a block diagram showing an optical disc apparatus according to a first embodiment of the present invention. In FIG. 1, reference numeral 1 denotes an optical disc which is an optical recording medium. The optical disc apparatus includes a spindle motor 2 for rotating the optical disc 1 which is mounted thereon and a spindle motor driver 3 for rotationally driving the spindle motor 3.

The optical disc apparatus further includes an optical pickup 6 for recording or reproducing information in or from the optical disc 1. The optical pickup 6 includes a semiconductor laser 7 serving as a light source, an objective lens 4 for condensing a beam from the semiconductor laser 7 onto a recording surface of the optical disc 1 to form spot light, an objective lens actuator 5, a laser driver 24 for controlling a light quantity of the semiconductor laser 7, other optical elements (not shown), and a sensor for detecting reflection light on the optical disc 1. The objective lens actuator 5 biaxially drives the objective lens 4 in a direction perpendicular to a disc surface and a horizontal direction in such a manner that a beam is focused on a recording surface (focusing; hereinafter referred to as “Fo”) in a state in which the beam follows the optical disc 1 having runout and tracks provided in the optical disc 1 are followed by the beam (tracking; hereinafter referred to as “Tr”).

The optical disc apparatus further includes an optical pickup driver 8 for controlling the objective lens actuator 5, the laser driver 24, and the like, a seek motor 9 for transferring the optical pickup 6 in a radius direction of the optical disc 1, a seek motor diver 10 for controlling the seek motor 9, and a disc-type determining means 27 for performing disc type determination on the recording layer of the optical disc 1 as described later.

The optical disc apparatus further includes a controller 11 which is composed of, for example, a CPU and a memory. The controller 11 performs servo/RF processings such as control processing of each of the drivers and processing of an output signal from a sensor provided in the optical pickup 6. In addition, the controller 11 controls an entire optical disc apparatus 12 to act as a central device for each sequential control. The optical disc apparatus 12 is composed of the above-mentioned constituent components. In this embodiment, the laser driver 24 for adjusting output power of the semiconductor laser 7 corresponds to a light quantity adjusting circuit.

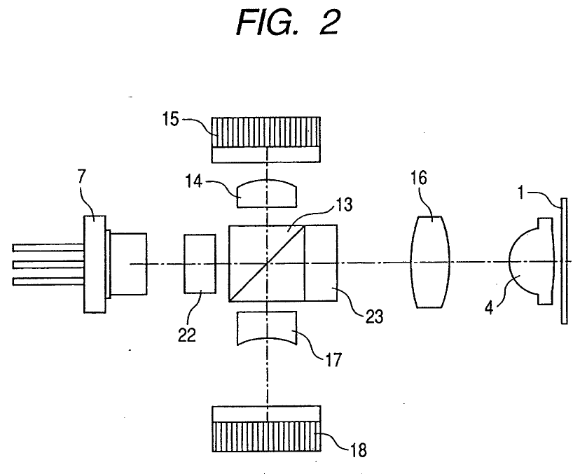

FIG. 2 shows an optical system of the optical pickup 6. A beam irradiated from the semiconductor laser 7 is separated into a main beam and two sub beams by a grating 22. The sub beams are used to generate a servo signal for differential push-pull (DPP).

A part of the beams passing through the grating 22 is reflected on a polarization beam splitter 13 and condensed to a monitor PD 15 by a condensing lens 14. An output of the monitor PD 15 is used to control the irradiation power of the semiconductor laser 7.

The beam passing through the polarization beam splitter 13 passes through a λ/4-plate 23 and is converted to a parallel beam by a collimator lens 16. Then, the beam is imaged by the objective lens 4 onto an information recording surface of the optical disc 1 through a transparent substrate thereof. The beam reflected on the optical disc 1 is reflected on the polarization beam splitter 13 through the objective lens 4, the collimator lens 16, and the λ4-plate 23. The reflected beam is condensed onto an RF servo PD 18 by the sensor lens 17. An information signal and the servo signal are obtained based on an output of the RF servo PD 18.

Next, the operation of the optical disc apparatus 12 will be described in detail. First, the optical pickup driver 8, the seek motor driver 10, and the spindle motor driver 3 are entirely controlled by the controller 11. Then, the spindle motor 2 is rotated at a desirable rotational rate by the spindle motor driver 3. Therefore, the optical disc 1 mounted on the spindle motor 2 is rotated together therewith.

The seek motor 9 which is a stepping motor is driven by the seek motor driver 10 to transfer the optical pickup 6 to an arbitrary position in the radius direction of the optical disc 1. The laser driver 24 is controlled through the optical pickup driver 8 to control laser light from the semiconductor laser 7 of the optical pickup 8. The laser light is condensed to the recording surface of the optical disc 1 by the objective lens 4 to record information or reproduce the recorded information.

At this time, as described above, the tracks provided in the recording surface of the optical disc 1 are followed by the objective lens 4. Therefore, a drive current (current flowing in Fo direction is Fo current and current flowing in Tr direction is Tr current) supplied to the objective lens actuator 5 is controlled by the optical pickup driver 8 based on an Fo error signal and a Tr error signal as described later. Note that the Fo error signal is obtained corresponding to a relative distance in a perpendicular direction between the objective lens 4 and optical disc 1 and becomes 0 in a focusing state. This signal is obtained by, for example, an astigmatic method.

On the other hand, the Tr error signal is obtained corresponding to a relative position in a parallel direction between a track provided in the recording surface of the optical disc 1 and a disc surface on which a spot is formed and becomes 0 in the case where the spot is located at substantially the center of the track. For example, this signal is obtained by a push-pull method or a differential push-pull method. The methods of generating the Fo error signal and the Tr error signal are known and thus the descriptions thereof are omitted here. In the present invention, methods which are other than the astigmatic method and the differential push-pull method can be certainly applied.

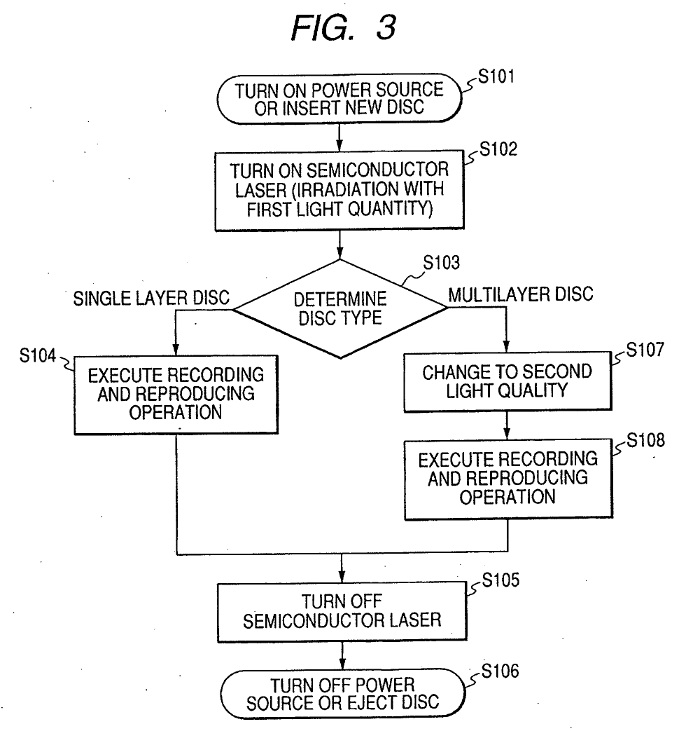

FIG. 3 is an explanatory flow chart showing an operation of the optical disc apparatus according to this embodiment. First, in the case where the disc type determination whether the optical disc 1 includes the single layer or the multilayer is required (S101), such as the case where the power source of the optical disc apparatus is turned ON or the case where the optical disc 1 is mounted on the spindle motor 2, the semiconductor laser 7 is tuned ON by the laser driver 24 in response to an instruction from the controller 11. Then, an output of the semiconductor laser 7 is controlled such that a quantity of laser light exited from the objective lens 4 becomes a reproducing light quantity for the single-layer disc (first light quantity) (S102) . The optical disc 1 is irradiated with the laser light. As described above, the first light quantity is a light quantity for reproducing information from the single-layer disc.

Next, it is determined whether the recording layer of the optical disc 1 is composed of the single layer or the multilayer (for example, two layers) by the disc-type determining means 27 under the control of the controller 11 (S103). The method of determining whether the recording layer is composed of the single layer or the multilayer is described later. When it is determined that the optical disc 1 is the single-layer disc, the recording operation or the reproducing operation is executed without the change of the reproducing light quantity (S104).

At this time, as described earlier, the preformat information is reproduced from the optical disc 1 with the first light quantity and recording or reproduction is performed based on the preformat information. At the time of recording, recording power is set. After the recording or the reproduction is completed, the semiconductor laser 7 is turned OFF by the laser driver 24 (S105). Then, the power source is turned OFF or the optical disc 1 is ejected (S106), thereby completing processing.

On the other hand, when it is determined that the optical disc 1 is the two-layer disc, the output of the semiconductor laser 7 is controlled by the laser driver 24 under the control of the controller 11. Therefore, the quantity of light exited from the objective lens 4 is adjusted to a reproducing light quantity for the two-layer disc (second light quantity=approximately two times the first light quantity) (S107) and the recording or the reproduction is performed (S108). In this case, the preformat information is reproduced from the optical disc 1 with the second light quantity and the recording or the reproduction is performed based on the preformat information. At the time of recording, the recording power is set. After the recording or the reproduction is completed, the semiconductor laser 7 is turned OFF (S105). Then, the power source is turned OFF or the optical disc 1 is ejected (S106), thereby completing processing. As described above, the second light quantity is a light quantity for reproducing information from the multilayer disc.

Next, a disc type determining method for the optical disc 1 according to this embodiment will be described in detail below. For example, when the objective lens 4 is moved up and down in the Fo direction and a quantity of light reflected on the optical disc 1 is detected by the RF servo PD 18, a signal whose peak becomes maximum when the light is focused on each layer is obtained. Therefore, the disc type can be determined based on the number of peaks indicating the focusing state.

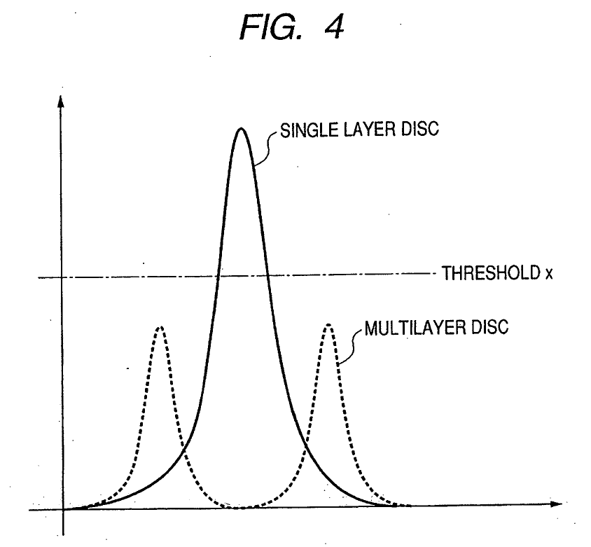

Therefore, as shown in FIG. 4, an arbitrary threshold x is set only when a single peak which exceeds the threshold x (indicated by a solid line shown in FIG. 4) is detected, it is determined that the optical disc 1 is the single-layer disc. When a peak is lower than the threshold x because of insufficient light quantity or when two peaks (indicated by a broken line shown in FIG. 4) are detected, it can be determined that the optical disc 1 is the two-layer disc. In this case, the light quantity can be adjusted to the second light quantity to perform the disc type determination again.

As described above, even in the case of the bare disc, when the disc type determination is performed with the first light quantity for reproducing information from the single-layer disc, whether the optical disc 1 is the single-layer disc or the multilayer disc can be determined without causing reproducing deterioration.

### SECOND EMBODIMENT

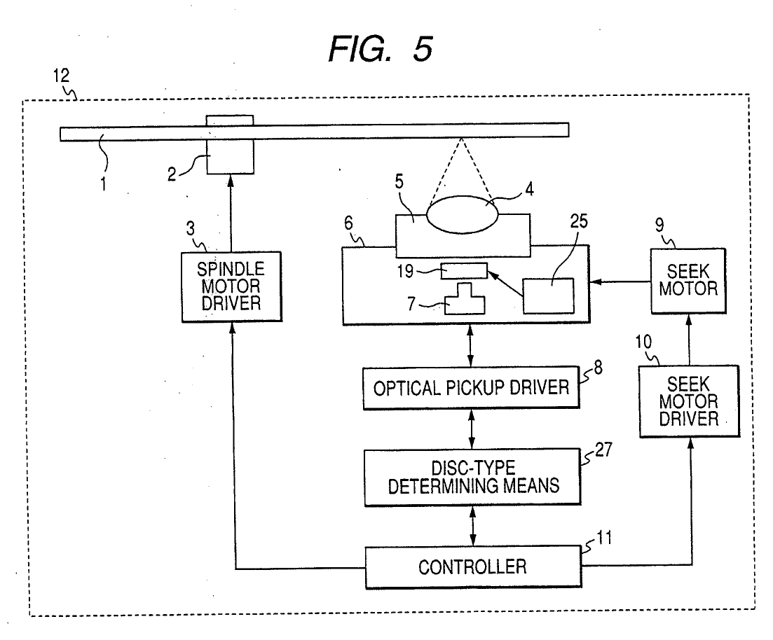

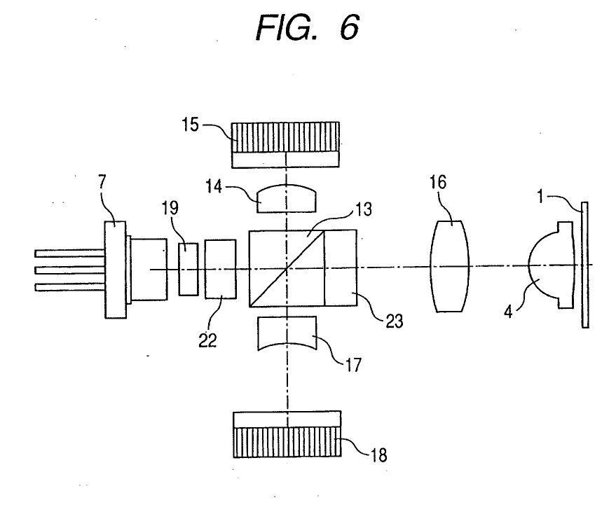

FIG. 5 is a block diagram showing an optical disc apparatus according to a second embodiment of the present invention. FIG. 6 is a structural diagram showing an optical system of an optical pickup 6 used for the optical disc apparatus. In FIGS. 5 and 6, the same reference symbols are provided for the same sections as those shown in FIGS. 1 and 2 of the first embodiment and thus the descriptions are omitted here.

A fundamental structure and a fundamental operation are identical to those of the first embodiment. In this embodiment, the light quantity is adjusted to the first light quantity or the second light quantity by using a light quantity attenuating device (polarization beam splitter and liquid crystal element) described in Japanese Patent Application Laid-Open No. 2004-199755. The light quantity adjusting method is described in Japanese Patent Application Laid-Open No. 2004-199755, so the description thereof is omitted here.

In FIGS. 5 and 6, reference numeral 19 denotes a liquid crystal element and 25 denotes a liquid crystal element driver for controlling the liquid crystal element 19. Although not shown in FIG. 5, the laser driver 24 shown in FIG. 1 is included in the optical pickup driver 8. In this embodiment, the polarization beam splitter 13, the liquid crystal element 19, and the liquid crystal element driver 25 compose the light quantity adjusting circuit.

As compared with the case where the liquid crystal element 19 is in a power OFF state, a molecular alignment state of the liquid crystal element 19 changes in a power ON state. The quantity of light exited from the objective lens 4 is attenuated by approximately 50% by a combination of the liquid crystal element 19 and the polarization beam splitter 13. Therefore, in this embodiment, the output light quantity of the semiconductor laser 7 at the time of information reproduction is constantly set to the reproducing light quantity for the multilayer disc and the power ON/OFF state of the liquid crystal element 19 is controlled. Thus, the quantity of the light exited from the objective lens 4 is adjusted to the first light quantity or the second light quantity.

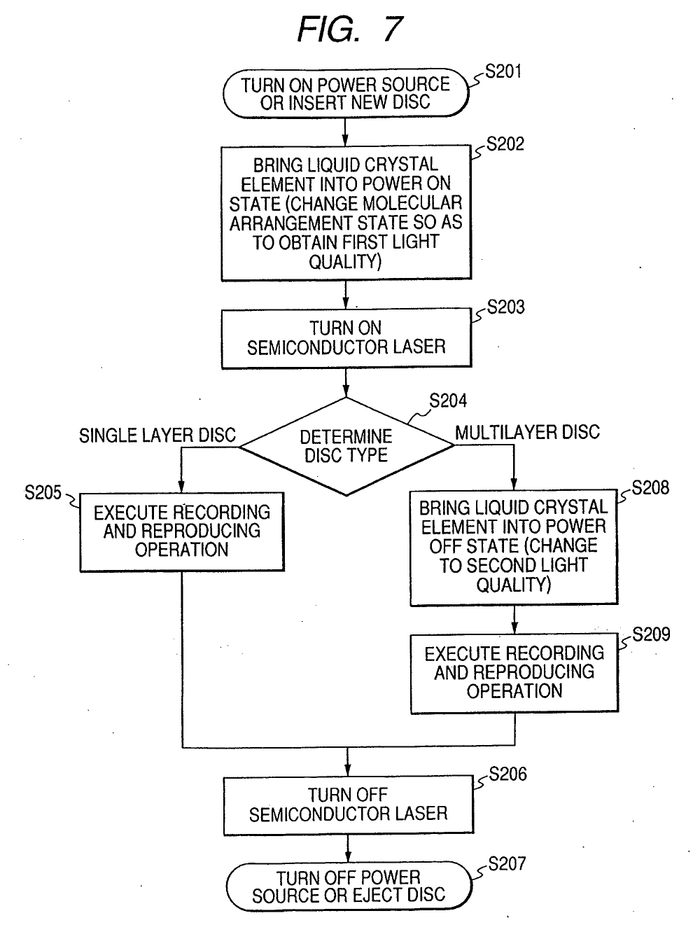

FIG. 7 is a flow chart showing a disc type determining operation for the optical disc according to this embodiment. When the power source of the optical disc apparatus is turned ON or when the optical disc 1 is inserted thereto (S201), the liquid crystal element driver 25 is controlled by the controller 11. Then, the liquid crystal element 19 is brought into the power ON state to change the molecular alignment state of the liquid crystal element 19 such that the quantity of light exited from the objective lens 4 becomes the first light quantity described above (S202).

Next, the semiconductor laser 7 is tuned ON (S203) and the disc type determination is performed with the first light quantity by the disc-type determining means 27 as in the first embodiment (S204) . When the disc-type determining means 27 determines that the optical disc 1 is the single-layer disc, recording or reproduction is performed without any change (S205). In this case, preformat information is reproduced from the optical disc 1 with the first light quantity and the recording or the reproduction is performed based on the preformat information. At the time of recording, recording power is set. After the recording or the reproduction is completed, the semiconductor laser 7 is turned OFF (S206) . Then, the power source is turned OFF or the optical disc 1 is ejected (S207), thereby completing processing.

On the other hand, when it is determined that the optical disc 1 is the multilayer disc (two-layer disc in this embodiment), the liquid crystal element driver 25 is controlled by the controller 11. The liquid crystal element 19 is brought into the power OFF state to change the molecular alignment state thereof, thereby adjusting the reproducing light quantity to the second light quantity (S208) . Then, the recording or the reproduction is performed (S209). In this case, the preformat information is reproduced from the optical disc 1 with the second light quantity and the recording or the reproduction is performed based on the preformat information. At the time of recording, the recording power is set. After the recording or the reproduction is completed, the semiconductor laser 7 is turned OFF (S206). Then, the power source is turned OFF or the optical disc 1 is ejected (S207), thereby completing processing.

As described above, when the polarization beam splitter 13 and the liquid crystal element 19 are used for the light quantity attenuating device, the high power state of the semiconductor laser 7 can be continuously maintained as compared with the case of the first embodiment. Therefore, it is possible to prevent deterioration of signal quality of the semiconductor laser 7 serving as the light source from being deteriorated by quantization noise. This is particularly effective for an optical disc apparatus using a blue laser, such as a Blu-ray disc apparatus in which various stress margins are tight as compared with a DVD apparatus or the like.

The present invention is not limited to only the structure of this embodiment. For example, when a polarization hologram is used instead of the polarization beam splitter 13 and combined with the liquid crystal element, the light quantity can be attenuated as in the above-mentioned case. The liquid crystal element 19 can be disposed between the grating 22 and the polarization beam splitter 13.

### THIRD EMBODIMENT

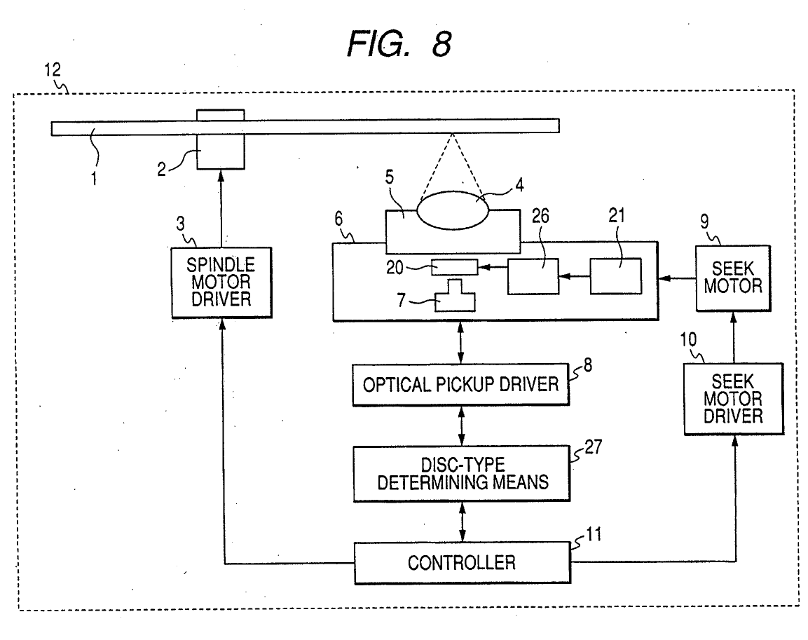

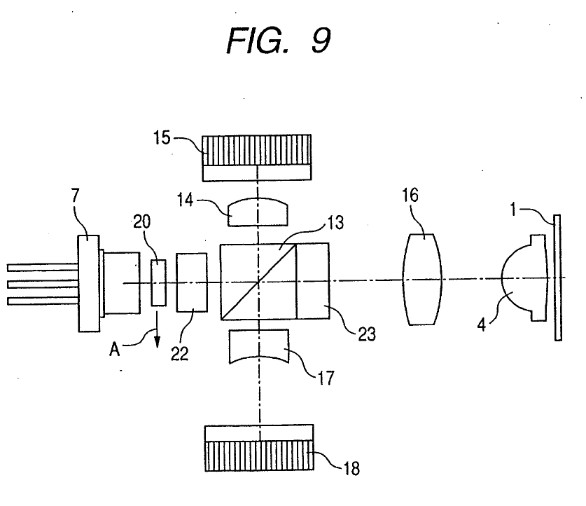

FIG. 8 is a block diagram showing an optical disc apparatus according to a third embodiment of the present invention. FIG. 9 is a structural diagram showing an optical system of an optical pickup 6 used for the optical disc apparatus. A fundamental structure and a fundamental operation are identical to those of the first and second embodiments. In FIGS. 8 and 9, the same reference symbols are provided for sections having the same functions as those of the first and second embodiments and thus the descriptions are omitted here. In this embodiment, the light quantity is adjusted to the first light quantity or the second light quantity by using a light quantity attenuating device described in Japanese Patent Application Laid-Open No. 2003-257072.

In FIGS. 8 and 9, reference numeral 20 denotes an optical filter serving as the light quantity attenuating device. The optical filter 20 is driven by an optical filter driving motor 26 serving as a stepping motor. The optical filter driving motor 26 is driven by a motor driver 21. The motor driver 21 is controlled by the optical pickup driver 8. Although not shown in FIG. 8, the laser driver 24 described in the first embodiment is included in the optical pickup driver 8.

The light quantity adjusting method is described in Japanese Patent Application Laid-Open No. 2003-257072, so the description thereof is omitted here. In this embodiment, the optical filter driving motor 26 is driven by the motor driver 21 and the optical filter 20 having transmittance of 50% is inserted to or removed from an optical axis, thereby adjusting the light quantity. In other words, the output light quantity of the semiconductor laser 7 is controlled to the reproducing light quantity for the multilayer disc (second light quantity) as in the second embodiment. In the case of the single-layer disc, the optical filter 20 is disposed on the optical axis to attenuate the light quantity, thereby adjusting the reproducing light quantity to the first light quantity. In the case of the multilayer disc, the optical filter 20 is moved in a direction indicated by an arrow “A” as shown in FIG. 9 to remove the optical filter 20 from the optical axis, thereby adjusting the reproducing light quantity to the second light quantity.

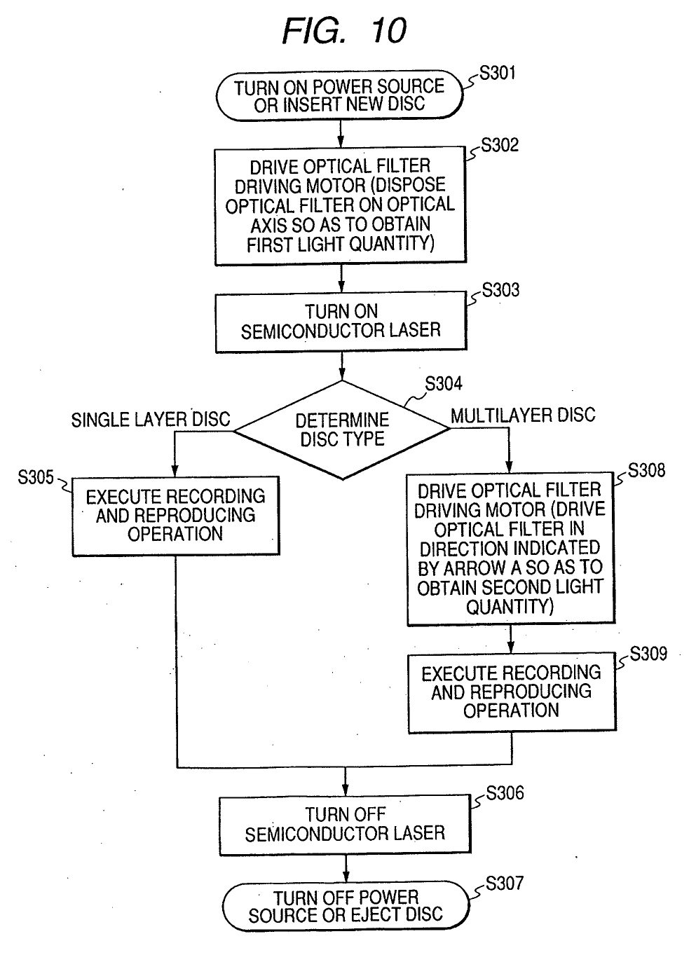

FIG. 10 is a flow chart showing an operation according to this embodiment. When the power source of the optical disc apparatus is turned ON or when the optical disc 1 is inserted thereto (S301), the motor driver 21 is controlled by the controller 11 and the optical filter 20 is disposed on the optical axis by the driving of the optical filter driving motor 26. Therefore, the quantity of light exited from the objective lens 4 is adjusted to the first light quantity (S302). Then, the semiconductor laser 7 is tuned ON by the controller 11 (S303) and the disc type determination is performed on the optical disc 1 by the disc-type determining means 27 as in the first and second embodiments (S304).

As a result of the disc type determination, when the optical disc 1 is the single-layer disc, recording or reproduction is performed without any change (S305) . In this case, preformat information is reproduced from the optical disc 1 with the first light quantity and the recording or the reproduction is performed based on the preformat information. At the time of recording, recording power is set. After the recording or the reproduction is completed, the semiconductor laser 7 is turned OFF (S306). Then, the power source of the optical disc apparatus is turned OFF or the optical disc 1 is ejected (S307), thereby completing processing.

On the other hand, when it is determined that the optical disc 1 is the multilayer disc (two-layer disc in this embodiment), the motor driver 21 is controlled by the controller 11 and the optical filter 20 is moved in a direction in which the optical filter 20 is removed from the optical axis (direction indicated by the arrow “A” shown in FIG. 9) by the driving of the optical filter driving motor 26. Therefore, the reproducing light quantity is adjusted to the second light quantity (S308) . Then, the recording or the reproduction is performed (S309). In this time, the preformat information is reproduced from the optical disc 1 with the second light quantity and the recording or the reproduction is performed based on the preformat information. At the time of recording, the recording power is set. After the recording or the reproduction is completed, the semiconductor laser 7 is turned OFF (S306). Then, the power source of the optical disc apparatus is turned OFF or the optical disc 1 is ejected (S307), thereby completing processing.

In this embodiment, the optical filter which can be inserted to or removed from the optical axis is used as the light quantity attenuating device, so that power consumption can be reduced as compared with the case of the second embodiment. This is because, when the liquid crystal element 19 is used, power is continuously supplied to the liquid crystal element 19 in a state of the first light quantity to maintain the molecular alignment state of the liquid crystal element 19.

In this embodiment, for example, when the optical filter 20 is inserted to or removed from the optical axis by using a stepping motor, a plunger, and the like, the power OFF state can be obtained during a time other than a time necessary to shift from the second light quantity to the first light quantity or from the first light quantity to the second light quantity, so that the power consumption can be reduced.

In the above-mentioned embodiments, it is assumed that the optical disc is the multilayer disc, more specifically, the number of layers is two. The present invention can be used even in the case of three or more-layer disc (medium) . That is, even in the case of the three or more layers, the reproducing light quantity for the disc type determination may be set to the first light quantity.

This application claims priority from Japanese Patent Application No. 2005-048993 filed Feb. 24, 2005, which is hereby incorporated by reference herein.

What is claimed is:

1. An optical information recording and reproducing apparatus, comprising:
a light source;
an objective lens for focusing laser light from the light source on an optical recording medium having a signal recording surface of a single layer or a multilayer to perform information recording or information reproduction;
a determining circuit for determining number of layers of the signal recording surface of the optical recording medium; and
an adjusting circuit for adjusting an intensity of the laser light irradiated to the optical recording medium,
wherein when the determining circuit determines the number of layers, the adjusting circuit sets an intensity of the laser light irradiated to the optical recording medium to an intensity for reproducing information from the optical recording medium having a single layer.

2. The optical information recording and reproducing apparatus according to claim 1, wherein the adjusting circuit controls output power of the light source.

3. The optical information recording and reproducing apparatus according to claim 1, further comprising a light quantity attenuating device provided on an optical path between the light source and the objective lens,
wherein the adjusting circuit controls the light quantity attenuating device.

4. The optical information recording and reproducing apparatus according to claim 3, wherein the light quantity attenuating device comprises a liquid crystal element and the light quantity attenuating device is controlled by switching between power ON/OFF states of the liquid crystal element.

5. The optical information recording and reproducing apparatus according to claim 3, wherein the light quantity attenuating device comprises an optical filter and the light quantity attenuating device is controlled by inserting and removing the optical filter to and from the optical path.
